(19) United States
(12) Patent Application Publication
(10) Pub. No.: US 2017/0253439 A1
(43) Pub. Date: Sep. 7, 2017

(54) HANDLING APPARATUS FOR A ROBOT DEVICE, ASSEMBLY STATION WITH THE HANDLING APPARATUS AND METHOD FOR ASSEMBLING A VEHICLE PANE ON A BODY SECTION USING THE HANDLING APPARATUS

(71) Applicant: GM GLOBAL TECHNOLOGY OPERATIONS LLC, Detroit, MI (US)

(72) Inventors: Claudia KRETZSCHMAR, Ruesselsheim (DE); Harald SCHENK, Ruesselsheim (DE); Judith APOLD, Ruesselsheim (DE)

(73) Assignee: GM GLOBAL TECHNOLOGY OPERATIONS LLC, Detroit, MI (US)

(21) Appl. No.: 15/448,348

(22) Filed: Mar. 2, 2017

(30) Foreign Application Priority Data
Mar. 3, 2016 (DE) 102016002489.5

(51) Int. Cl. B65G 49/06; B25J 15/06

(52) U.S. Cl. CPC B65G 49/061; B25J 15/0616

(57) ABSTRACT

A robot handling apparatus is disclosed for assembling a vehicle pane on a body section of a vehicle body in an assembly station. The handling apparatus includes an interface for coupling the handling apparatus to the robot device, and a holding device for holding the vehicle pane in a pane plane. The holding device is moveable in a first translational degree of freedom along XR-linear axis of the handling apparatus in an XR-direction relative to the interface and parallel to the pane plane. The holding device is also moveable in a second translational degree of freedom along the Y-linear axis of the handling apparatus in a Y-direction relative to the interface and parallel to the pane plane.

### CROSS-REFERENCE TO RELATED APPLICATION

The application claims priority to German Patent Application No. 102016002489.5, filed Mar. 3, 2016, which is incorporated herein by reference in its entirety.

### TECHNICAL FIELD

The present disclosure pertains to a handling apparatus for a robot device for a vehicle pane such as a windshield or back window for assembly on the body section of the vehicle body, and further relates to an assembly having the handling apparatus and to a method for assembling a vehicle pane on a body section of a vehicle body in an assembly station.

### BACKGROUND

Usually, vehicle parts are manually moved by a worker from a provisioning surface or application cell to an assembly position using a manually guided handling apparatus. However it is also known that the vehicle parts are fully automatically moved from the provisioning surface or application cell to the assembly position by robots. The worker finally positions and adjusts the vehicle part in the assembly part using a handling apparatus.

For example, the publication DE 10 2014 002 722 A1 describes a method for assembling a vehicle part on a vehicle body in an assembly station. With the method, a handling apparatus is used which includes a robot device, a gripper device and an end positioning device. The handling apparatus grips the vehicle part with the gripper device in a transfer position and pre-positions the vehicle part in an assembly position using the final positioning device. There, the worker assembles the vehicle part on the vehicle body using the final positioning device.

### SUMMARY

The present disclosure provides a functionally improved handling apparatus for final assembly. A handling apparatus for a robot device for assembling a vehicle pane on a body section of a vehicle body in an assembly station is provided. For example, the robot device is configured as a Cartesian robot or as an articulated arm robot.

The handling apparatus includes an interface which is configured to couple the handling apparatus to the robot device. Because of this, the handling apparatus is moveable in the assembly station in a state in which it is coupled to the robot device. Preferably, the handling apparatus is configured to be guided and/or handled by a worker. With the assistance of the handling apparatus, the worker can grip, hold and move the vehicle pane to the body section. In particular, the handling apparatus assists the worker during the pre-assembly and optionally complementarily even during the final assembly of the vehicle pane on the body section. The vehicle body is preferably a vehicle body of a passenger car. The body section forms a section of the vehicle body in the region of the windshield and/or back window. Preferably, the vehicle pane is designed as a windshield or back window for assembly on the body section of the vehicle body.

Within the scope of the present disclosure it is preferred that the vehicle body is completed to form a vehicle within the assembly station that is ready for use on the road. Optionally, the vehicle body is conveyed on a production line of the assembly station, for example on a transport or conveyor belt, via an automatic machine and/or via the robot device into the assembly station and/or through the assembly station. It is possible within the scope of the present disclosure that the production line for assembling the vehicle pane on the body section stops and restarts again. In particular, the vehicle body in this case stands still during a pre- and/or final assembly of the vehicle pane on the body section. However it is particularly preferred that the vehicle pane within the scope of a flowing production, during which the production line does not stop, is assembled on the body section. In this preferred embodiment, conveying the vehicle body takes place steadily, without interruption and/or without stopping.

The handling apparatus includes a holding device which is configured to hold the vehicle pane in a pane plane, in particular in a pane plane defined by the vehicle pane. For example, the holding device includes at least one gripper device, with which the vehicle pane can be gripped and held. For example, the at least one gripper device is designed as at least one suction cup. In particular, when placing the at least one suction cup, a vacuum develops between the vehicle pane and the suction cup, through which the vehicle pane is fastened on the suction cup.

Preferably, the gripped and held vehicle pane is moveable with the handling apparatus by the worker, to the pre-assembly and final assembly. Optionally, the handling apparatus includes a compensation device which is configured to compensate a weight of the vehicle pane. The compensation device is configured as at least one cylinder, which for example can create a counterweight to the vehicle pane. Because of this, a weight of the vehicle pane can be offset, which is advantageous in particular for the worker since he can more easily move the same with less exertion of force using the handling apparatus.

The handling apparatus includes an XR-linear axis and a Y-linear axis. In a first translational degree of freedom, the holding device is moveable along the XR-linear axis in an XR-direction. The movement in the XR-direction takes place relative to the interface and parallel to the pane plane. In a second translational degree of freedom, the holding device is moveable along the Y-linear axis in a Y-direction. The movement in the Y-direction takes place relative to the interface and parallel to the pane plane.

It is advantageous that because of the possible movement of the holding device in XY-direction and in the Y-direction, handling of the handling apparatus can be improved ergonomically for the worker during the pre- and/or final assembly of the vehicle pane on the body section. In particular, through the possibility of moving the holding device in the XR and Y-direction relative to the interface and parallel to the pane plane, the vehicle pane can be final-positioned more easily, more precisely and more rapidly and even fine-adjusted. Because of this, working time during the pre- and/or final assembly of the vehicle pane on the body section can be advantageously saved. Optionally, the worker uses at least one spacer and/or at least one gauge for the final assembly and/or final adjustment of the vehicle pane on the body section.

In a preferred embodiment of the present disclosure, the holding device is arranged on the XR-linear axis and moveable through the same. Preferably, the XR-linear axis includes a first displacement pair. In particular, the first displacement pair includes a first guide rail and a first carriage which is displaceable in the XR-direction on the guide rail. It is particularly preferred that the holding device is arranged on the first carriage and because of this is moveable in the XR-direction. Optionally complementarily, the Y-linear axis includes a second displacement pair with a second guide rail and a second carriage that is displaceable on the guide rail. In particular, the second carriage is displaceable in the Y-direction on the second guide rail.

In a particularly preferred implementation of the present disclosure, the XR-linear axis stands in a kinematic chain with the Y-linear axis. Because of this, the XR-linear axis is moveable in the Y-direction via the Y-linear axis. For example, the first guide rail is arranged on the second carriage for this purpose. Because of this, the holding device is moveable relative to the interface and parallel to the pane plane in Y-direction jointly with the XR-linear axis.

A particularly preferred configuration of the present disclosure provides that the Y-linear axis is designed as a Y-linear axis of rotation. Preferably, the Y-linear axis of rotation is rotatable in a Yᵣₒₜ-direction in a rotatory degree of freedom. It is particularly preferred that the XR-linear axis is arranged in a kinematic chain with the Y-linear axis of rotation. Because of this, the XR-linear axis is rotatable in the Yᵣₒₜ-direction. Optionally complementarily, the holding device is rotatable, in particular jointly with the XR-linear axis, in about the Y-linear axis of rotation in the Yrot-direction. Because of the possibility of rotation about the Y-linear axis of rotation it is advantageously achieved that the vehicle pane can be positioned and aligned according to various installation angles of various vehicle body types. This can be activated either automatically or manually adjusted by a worker during the assembly of the vehicle pane. Because of this, the assembly can take place flexibly even with different vehicle body types.

In a preferred embodiment of the present disclosure, the handling apparatus includes an X-linear axis with a third displacement pair. Preferably, the third displacement pair includes a third guide rail and a third carriage, which is displaceable on the guide rail in an X-direction.

Within the scope of the present disclosure it is particularly preferred that the Y-linear axis and/or the Y-linear axis of rotation is connected to the X-linear axis in a kinematic chain. Preferably, the Y-linear axis and/or the Y-linear axis of rotation is arranged on the third carriage of the third displacement pair. Because of this, the Y-linear axis and/or the Y-linear axis of rotation is moveable in the X-direction. Optionally complementarily, the holding device is moveable in a third translational degree of freedom in the X-linear axis in the X-direction relative to the interface. In particular, the handling apparatus is freely mounted in the X-direction. Because of this, movements or trailing distances can be offset during a stop in the production line. This is of great advantage in particular for the assembly of the vehicle pane within the scope of the flow production.

A preferred design implementation of the present disclosure provides that the Y-linear axis and/or the Y-linear axis of rotation runs at a right angle or perpendicularly to the X-linear axis in a top view from above onto the handling apparatus. Preferably, the XR-linear axis in the top view from above runs angularly or equi-directionally to the X-linear axis as a function of a degree of rotation about the Y-linear axis of rotation.

A further subject of the present disclosure relates to an assembly station with the handling apparatus according to the previous description. The assembly station includes the handling apparatus. Optionally complementarily, the assembly station includes the robot device, the vehicle body, and/or the vehicle pane. In a preferred configuration, the handling apparatus is coupled via the interface to the robot device and assumes a coupled state. In the coupled state, the handling apparatus is placed as a tool onto the robot device. Thus, the handling apparatus can be moved and/or guided by the robot device.

Within the scope of the present disclosure it is particularly preferred that the robot device is transferrable from an active state, in which the robot device is set moveable, into a secured state, in which it is set reduced in speed or even incapable of moving. For example, the robot device can carry the handling apparatus with it in the active state. In particular, the robot device in the secure is reduced in the movement speed or shut down-for safety reasons. The safety shutdown can take place by de-energizing the robot device. It is also possible within the scope of the present disclosure that the robot device in the secured state is brake-locked and/or immovable.

Preferably, the assembly station includes the production line, on which the vehicle body is arranged. In particular, the vehicle body is conveyed by the assembly station in a movement direction.

In a preferred configuration of the present disclosure, the X-linear axis of the handling apparatus is equi-directional and/or parallel to a longitudinal axis of the vehicle body, which is preferably arranged on the production line and in particular conveyed in the movement direction. Alternatively or optionally complementarily, the Y-linear axis and/or the Y-linear axis of rotation runs equi-directional and/or parallel to a transverse axis of the vehicle body.

Within the scope of the present disclosure, the assembly station includes a provisioning position for the vehicle pane. Optionally, the handling apparatus can grip the vehicle pane in the provisioning position. Preferably, a provisioning device is arranged for this purpose in the provisioning position, which provisioning device is configured for example as a provisioning table, on which a plurality of vehicle panes to be assembled are provided for gripping by the handling apparatus.

A preferred implementation of the present disclosure provides that the assembly station includes an assembly position in which the vehicle pane is arranged for pre- and/or final assembly by the worker. Preferably, the assembly position is located directly on the vehicle body, which is arranged on the production line. In particular, the assembly position is determined by the body section on which the vehicle pane is assembled.

It is possible, within the scope of the present disclosure, that the assembly station includes a safety zone for the worker. Preferably, the safety zone is a spatially limited region which extends in an active region of the robot device, between the provisioning position and the assembly position. Optionally complementarily, the assembly station includes a monitoring device and a control device. The monitoring device is configured to monitor the safety zone. The control device is designed in particular for enabling the active or secured state of the robot device.

Preferably, the monitoring device monitors an access or approach of the safety zone by the worker when the robot device is in the active state. Optionally complementarily, the control device sets the robot device into the secured state when the worker accesses or approaches the safety zone. Because of this, the worker can be advantageously protected from colliding with the robot device.

In a particularly preferred implementation of the present disclosure, the robot device is set into the secured state when the handling apparatus with the gripped vehicle pane is in the assembly position. Because of this, the worker can approach the handling apparatus and use the same in order to pre- and/or final assemble the vehicle pane on the body section.

A further subject of the present disclosure is formed by a method for assembling the vehicle pane on the vehicle section of the vehicle body in the assembly station using the handling apparatus according to the previous description.

Within the scope of the method, the holding device is moved in the assembly position and for pre- and final assembly by the worker, in a first translational degree of freedom along the XR-linear axis in the XR-direction relative to the interface and parallel to the pane plane. In a second translational degree of freedom the holding device is moved within the scope of the method along the Y-linear axis and/or the Y-linear rotational axis in the Y-direction relative to the interface and parallel to the pane plane.

In a preferred method step, the robot device moves the handling apparatus in the coupled state to the provisioning position. Preferably, the handling apparatus accepts the vehicle pane in the provisioning position by gripping the same with the at least one gripper device. In particular, the robot device subsequently moves the handling apparatus with the gripped vehicle pane through the safety zone to the assembly position. There, the robot device positions the vehicle pane in the assembly position for pre- and/or final assembly by the worker. In particular, working time of the worker for transporting the vehicle pane to the body section can be saved compared with a conventional handling apparatus, in the case of which the vehicle pane is transported manually and not by the robot device. Furthermore, the transport by the robot device also facilitates the work for the worker.

Within the scope of the method it is preferred that the safety zone is set active during the transfer of the vehicle pane from the provisioning position into the assembly position. With activated safety zone, the robot device is set into the secured state when the worker enters or approaches the safety zone. In particular, the monitoring device transmits a signal to the control device when the worker approaches or enters the safety zone. Consequently, the control device activates the setting of the robot device into the secured state.

Optionally complementarily, the robot device with activated safety zone is set into the secured state, when the handling apparatus is arranged in the assembly position. Preferably, the robot device positions the handling apparatus in the assembly position so that the vehicle pane is spaced at a distance of maximally 40 millimeters, preferably of maximally 30 millimeters from the body section. Because of this it is achieved that the worker himself has to move the handling apparatus only a few millimeters towards the body section. Any required force expenditure for the worker can be advantageous reduced.

When the worker carries out the pre- and final positioning with the handling apparatus, expensive and error-prone vision systems can be advantageously omitted. Such vision systems are usually employed when the pre- and/or final assembly is carried out by the robot device.

Within the scope of the method it is preferred that the robot device moves up to a gluing station which is arranged between the provisioning position and the assembly position. For example, the gluing station includes a spray nozzle device for applying an adhesive to the vehicle pane. In particular, the adhesive is applied to the vehicle pane in the gluing station for gluing to the body section later on. Application can be effected for example that the robot device interrupts the conveying of the vehicle pane and positions the same in the direction of the spray nozzle device. The spray nozzle device applies the adhesive to the vehicle pane.

### BRIEF DESCRIPTION OF THE DRAWINGS

The present disclosure will hereinafter be described in conjunction with the following drawing figures, wherein like numerals denote like elements.

FIG. 1 shows a handling apparatus for a robot device for assembling a vehicle pane on a body section of a vehicle body in an assembly station;

FIG. 2 is a top view from above of an assembly station, wherein the handling apparatus is arranged in a provisioning position; and

FIG. 3 is the assembly station from FIG. 2, wherein the handling apparatus is arranged in an assembling position.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

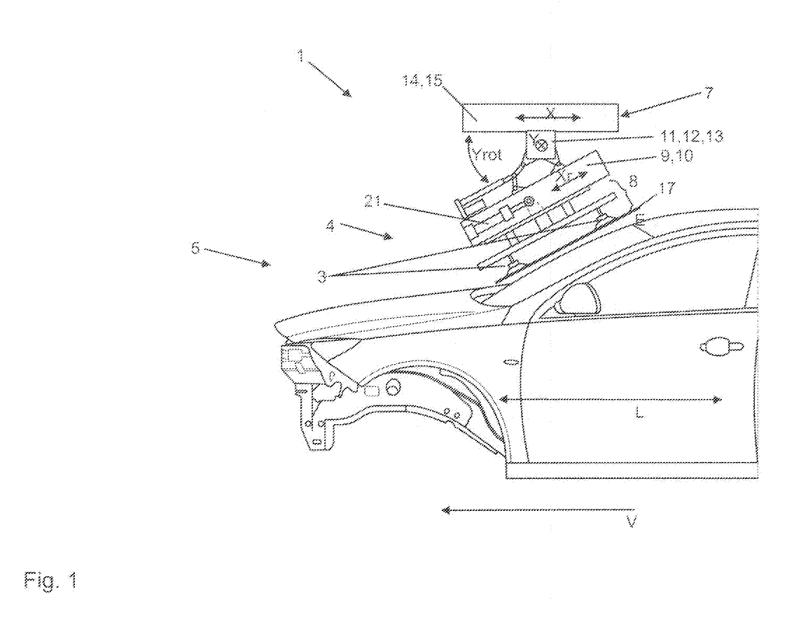

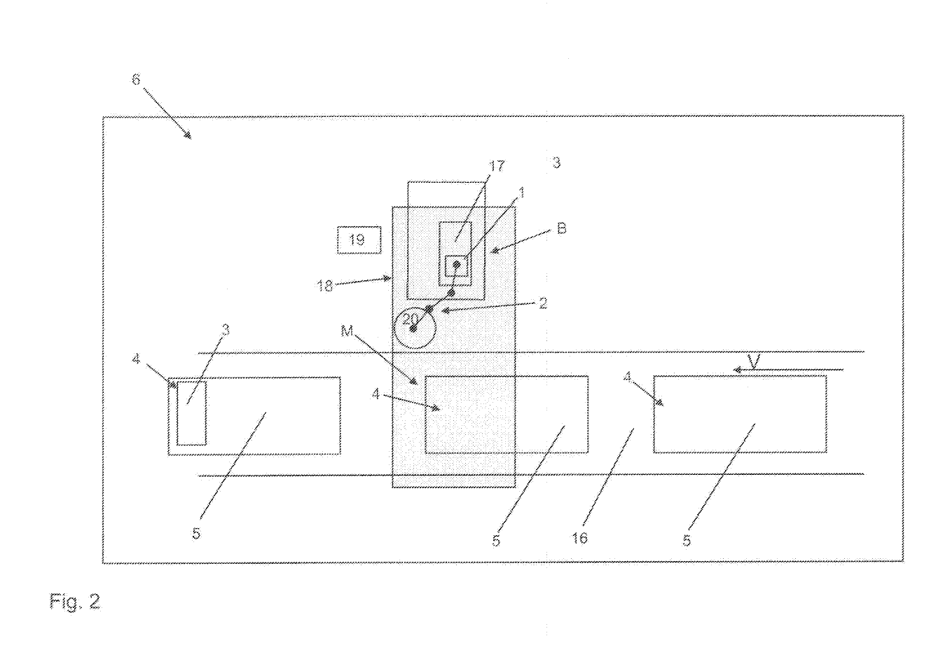

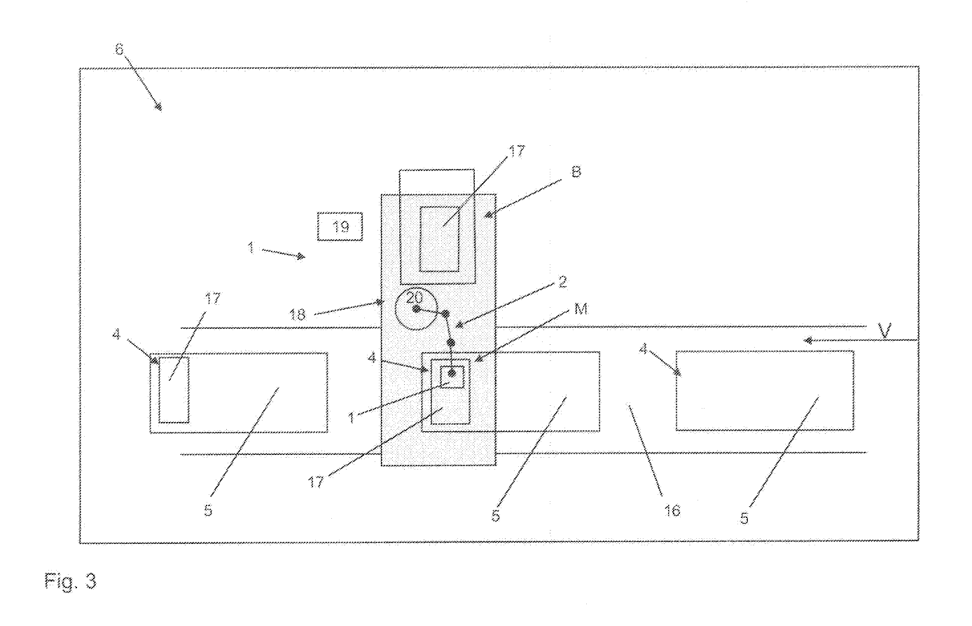

FIG. 1 shows a handling apparatus 1 for a robot device 2 (FIGS. 2-3) for assembling a vehicle pane 17 on a body section 4 of a vehicle body 5 (FIGS. 2-3) in an assembly station 6 (FIGS. 2-3).

The handling apparatus 1 includes an interface 7, via which it can be coupled to the robot device 2 and is transferrable into a coupled state (K). The vehicle body 5 is designed as a body of a passenger car. The body section 4 is arranged in a windshield region of the vehicle body 5. Alternatively, the body section 4 can also be arranged in a rear window region of the vehicle body 5. The vehicle body 5 is arranged on a production line 15 (FIG. 2) of the assembly station 6, in particular on a transport and/or conveyor belt and is moved by the same in a movement direction X.

The handling apparatus 1 includes a holding device 8 with at least one gripper device 3. The at least one gripper device 3 is designed as at least one suction cup. The vehicle pane 17 can thus be gripped and held by the gripper device 3 by generating a vacuum. In the held state, the vehicle pane 17 forms a pane plane E.

The handling apparatus 1 includes an XR-linear axis 9. The XR-linear axis 9 includes a first displacement pair with a first guide rail (not shown) and a first carriage 10. The carriage 10 is displaceable on the first guide rail along the XR-linear axis 9 in a first translational degree of freedom in an XR-direction (XR).

The holding device 8 is arranged on the first carriage 10 and because of this moveable in the XR-direction (XR) relative to the interface 7 and parallel to the pane plane E.

The handling apparatus 1 includes a Y-linear axis 11 which is designed as a Y-linear axis of rotation 12. In particular, the Y-linear axis of rotation 12 is designed as a shaft which can rotate in a Yᵣₒₜ-direction. The Y-linear axis 11 runs equi-directionally to a transverse extent of the vehicle body 5.

The Y-linear axis 11 includes a second guide pair with a second guide rail and a second carriage 13. The second carriage 13 is displaceable on the second guide rail along the Y-linear axis 11 in a second translational degree of freedom in a Y-direction (Y).

The XR-linear axis 9 is arranged in a kinematic chain with the Y-linear axis 11 and/or with the Y-linear axis of rotation 12. In particular, the first guide rail is connected to the second carriage 13 of the Y-linear axis and displaceable with the same in the Y-direction. Because of this, the holding device 8 which is arranged on the first carriage 10 of the XR-linear axis 9 is moveable relative to the interface 7 and parallel to the pane plane E in the Y-direction.

Furthermore, the first guide rail and/or the XR-linear axis 9 is rotatably coupled to the Y-linear axis of rotation 12, so that the first guide rail and/or the XR-linear axis 9 is rotatable about the Y-linear axis of rotation 12. Simultaneously, the holding device 8 is rotatable about the YR-linear axis of rotation 12 in the Yᵣₒₜ-direction ( Yᵣₒₜ). Because of this, the vehicle pane can be adapted to various required installation angles for different vehicle body types, in particular positioned and aligned accordingly. Because of this, the assembly of the vehicle pane rendered more flexible. Expensive retooling times can thus be avoided.

The handling apparatus 1 includes an X-linear axis 14 with a third displacement pair, which includes a third guide rail and a third carriage 15. The third carriage 15 is displaceable on the third guide rail in a third translational degree of freedom in an X-direction (X). The X-direction runs equi-directionally to a longitudinal direction L of the vehicle body 5.

The Y-linear axis 11 and/or the Y-linear axis of rotation 12 are arranged with the X-linear axis 14 in a kinematic chain. In particular, the second guide rail is connected to the third carriage 15 of the X-linear axis 14 and displaceable with the same in the X-direction (X). Because of this, the holding device 8 can also be moved relative to the interface 7 in the X-direction (X). In particular within the scope of flow production this is advantageous since movements or trailing distances during a stop in the production line can be offset through the movement in the X-direction.

The handling apparatus 1 includes at least one weigh regulation device 21, which is configured for example as at least one cylinder. For example, a counterweight to the weight of the vehicle pane 17 is generated by the weight regulation device 21.

FIGS. 2 and 3 show a top view from above of the assembly station 6. The assembly station 6 includes the handling apparatus 1, the vehicle pane 17, the robot device 2, the vehicle body 5 and the production line 16.

The assembly station 6 includes a provisioning position (B) and an assembly position (M). In the provisioning position (B), the vehicle pane 17 to be assembled is provided for gripping by the handling apparatus 1. In the assembly position (M), the handling apparatus 1 holds the vehicle pane 17 for pre- and/or final assembly by the worker on the body section 4.

Between the provisioning section (B) and the assembly position (M), a safety zone 18 is arranged. The assembly station 6 includes a monitoring device 19 for monitoring the safety zone 18 and a control device 20 for activating the robot device 2.

The robot device 2 is designed as an articulated arm and/or joint arm robot. As articulated and/or joint arm robot, the robot device 2 can perform pivot and/or rotation movements within at least two degrees of freedom.

The handling apparatus 1 as a tool is coupled to the robot device 2. In particular, the handling apparatus 1 is arranged on the robot device 2, wherein the robot device 2 can carry the handling apparatus 1 along with it.

According to FIG. 2, the robot device 2 moves the handling apparatus 1 to the provisioning position (B), in which the handling apparatus 1 grips the vehicle pane 17. Following this, the robot device 2 conveys the handling apparatus 1 with the vehicle pane 17 through safety zone 18 to the assembly position (M), as shown in FIG. 3. It is possible that between the provisioning position (B) and the assembly position (M) a gluing station (K) is intermediate-connected, on which an adhesive is applied on the vehicle pane 17 for gluing to the body section 4 later on.

In the assembly position (M) according to FIG. 3, the handling apparatus 1 is positioned by the robot device 2 so that the vehicle pane 17 is maximally spaced 40 millimeters, in particular maximally 30 millimeters from the body section 4. A worker uses the handling apparatus 1 in order to pre- and/or final-position and optionally additionally fine-adjust the vehicle pane 17 on the body section 4.

To this end, the worker moves the handling apparatus 1 to the body section 4 and places the vehicle pane 17, if applicable with the help of at least one gauge or at least one spacer, onto the body section 4. The at least one weight control device 21 (FIG. 1) serves as counterweight to the weight of the vehicle pane 17 and therefore facilitates moving and guiding the handling apparatus 1 by the worker. Accordingly, the worker has to expend less force during the assembly.

Because of the fact that the holding device 8 (FIG. 1) according to the description in FIG. 1 is moveable in up to 4 degrees of freedom, the final assembly, in particular fine adjustment of the vehicle pane 17 on the body section 4 by the worker can take place. An automated assembly by the robot device 2 and expensive vision systems required for this purpose can be advantageously omitted.

The robot device 2 can be set by the control device 20 from an active state into a secured state. In the active state, the robot device 2 can move in the safety zone 18 and convey the handling apparatus 1 from the provisioning position (B) to the assembly position (M). In the secured state, the robot device 2 is reduced in its movement speed. In particular, the speed is adapted to a line speed of the production line 16. Here, the robot device 2 jointly with the handling apparatus 1 and the gripped vehicle pane 17 steadily moves on in the movement direction (V) and does not stop in the process. A speed, in particular clocking of the provision of the vehicle body 5 on the production line 16 and of the vehicle pane 17 by the handling apparatus 1 arranged on the robot device 2 is matched to one another. Alternatively it is possible that the robot device 2 in the secured state is set incapable of movement. This is the case in particular when the production line 16 stops at the body section 4 for the final assembly of the vehicle pane 17.

When the worker approaches the safety zone 18 and/or when the worker enters the safety zone 18, this is detected by the monitoring device 19 as a consequence of which the control device 20 sets the robot device 2 into the secured state. Because of this, the worker is protected from colliding with the robot device 2. The robot device 2 is then also set in the secured state in particular when the handling apparatus 1 with the vehicle pane 17 is arranged in the assembly position (M).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A handling apparatus for a robot device configured to assemble a vehicle pane on a body section of a vehicle body in an assembly station, the handling apparatus comprising:
an interface configured to couple the handling apparatus to the robot device;
a holding device configured to hold the vehicle pane in a pane plane, wherein the holding device is moveable: (a) in a first translational degree of freedom along the XR-linear axis of the handling apparatus in an XR-direction relative to the interface and parallel to the pane plane; and (b) in a second translational degree of freedom along the Y-linear axis of the handling apparatus in a Y-direction relative to the interface and parallel to the pane plane.

17. The handling apparatus according to claim 16, wherein the holding device is arranged on the XR-linear axis and moveable thereby.

18. The handling apparatus according to claim 16, wherein the holding device is moveable in a rotational degree of freedom about the Y-linear axis in a Yrot-direction.

19. The handling apparatus according to claim 18, wherein the XR-linear axis stands in a kinematic chain with at least one of the Y-linear axis and the Y-linear axis of rotation (12).

20. The handling apparatus according to claim 16, wherein the holding device comprises an X-linear axis.

21. The handling apparatus according to claim 20, wherein the holding device is moveable in a third translational degree of freedom along the X-linear axis in an X-direction relative to the interface.

22. The handling apparatus according to claim 20, wherein the Y-linear axis is connected to the X-linear axis in a kinematic chain.

23. The handling apparatus according to claim 20, wherein the holding device is moveable in a rotational degree of freedom about the Y-linear axis in a Yrot-direction and the Y-linear axis is connected to the X-linear axis in a kinematic chain.

24. The handling apparatus according to claim 20, wherein the Y-linear axis in a top view from above on the handling apparatus runs perpendicularly to the X-linear axis.

25. The handling apparatus according to claim 20, wherein XR-linear axis runs as a function of a degree of rotation about the Y-linear axis angularly to the X-linear axis.

26. The handling apparatus according to claim 20, wherein XR-linear axis runs as a function of a degree of rotation about the Y-linear axis equi-directionally to the X-linear axis.

27. The handling apparatus according to claim 20, wherein the X-linear axis comprises a first displacement pair including a first guide rail and a first carriage that is displaceable on the guide rail.

28. The handling apparatus according to claim 27, wherein the X-linear axis comprises a second displacement pair including a second guide rail and a second carriage that is displaceable on the second guide rail.

29. The handling apparatus according to claim 28, wherein the X-linear axis comprises a third displacement pair including a third guide rail and a third carriage that is displaceable on the third guide rail.

30. An assembly station comprising the handling apparatus according to claim 16 and a robot device coupled to the interface.

31. The assembly station according to claim 30, further comprising a production line for a vehicle body, wherein the X-linear axis of the handling apparatus runs parallel to a longitudinal axis of the vehicle body on the production line and the Y-linear axis runs parallel to a transverse axis of the vehicle body on the production line.

32. The assembly station according to claim 31, wherein the assembly station further comprises a provisioning position configured for gripping the vehicle pane with the handling apparatus, an assembly position configured for of the vehicle pane onto the vehicle body by the worker, a safety zone between the provisioning position and the assembly position configured for a worker, and a monitoring device configured to monitor the safety zone.

33. A method for assembling a vehicle pane on a body section of a vehicle body in an assembly station comprising:
coupling an interface on a handling apparatus to a robot device;
holding a vehicle pane in a pane plane with a holding device;
moving the holding device in a first translational degree of freedom along the XR-linear axis in an XR-direction relative to the interface and parallel to a pane plane with a first displacement pair; and
moving the holding device in a second translational degree of freedom along a Y-linear axis relative to the interface and parallel to a pane plane with a second displacement pair.

34. The method according to claim 33 further comprising rotating the holding device in a first rotational degree of freedom about the Y-linear axis.

35. The method according to claim 33, further comprising:
accepting the vehicle pane with the handling apparatus in a provisioning position;
activating the handling apparatus when a worker enters a safety zone is a secure state; and
positioning the vehicle pane with the handling apparatus in an assembly position assembly by the worker when in the secure state.
